(19) United States
(12) Patent Application Publication
(10) Pub. No.: US 2003/0200535 A1
(43) Pub. Date: Oct. 23, 2003

(54) System for program source code conversion

(76) Inventor: Benedict Bede McNamara, New South Wales (AU)

Correspondence Address: YOUNG & THOMPSON, 745 SOUTH 23RD STREET 2ND FLOOR, ARLINGTON, VA, 22202

(21) Appl. No.: 10/297,715

(22) PCT Filed: Jun. 8, 2001
(86) PCT No.: PCT/AU01/00685

(30) Foreign Application Priority Data
Jun. 9, 2000 (AU) PQ815

(51) Int. Cl. G06F 9/45

(52) U.S. Cl. 717/137

(57) ABSTRACT

A computer system/program (10) for converting at least keywords in a program source code. The system/program (10) has a program source code conversion means (12) for converting C/C++ source codes including C/C++ keywords written in a non-English language such as French or Spanish into a form that can be compiled by a standard compiler, storage means (20) storing English keywords of C/C++ and words in at least one other natural language corresponding to said keywords, and program code conversion for converting keywords and other words written in one natural language into a target code in another natural language. The system/program (10) can be in the form of a compiler or incorporated into a computer operating system so that the natural language for the system interface can be selected.

### TECHNICAL FIELD OF THE INVENTION

THIS invention relates to a computer system/program for converting program source code written in one natural language to target source code in another natural language.

This invention also relates to a high level program adapted for facilitating of source code written in a non-English language for compilation into a machine code with an English language high level program,

This invention further relates to a convertible interface system for a computer operating system having conversion means for selectively converting an interface to be presented in a selected a natural language.

### BACKGROUND OF THE INVENTION

Computer program developments generally involve writing source code in a high level programming language such as C++. Program statements in the source code are then translated or compiled by a compiler program into machine code that can be executed in a computer system.

Programmers prefer to write program source code in a high level computer language as they can write the code statements and instructions in a natural language-like structure which allow them to easily write and if required debug the codes. “C”, “C++”, Pascal, Basic, COBOL and Fortran are examples of the high level languages.

Compilers are computer programs which translate program source codes into machine instructions, generally called machine code, which the computer system can understand and execute.

High level programming languages have a set of keywords which cannot be redefined in source code. This is so that the compilers can translate them into appropriate machine instructions. As the compilers are developed in English speaking countries all the keywords are English based. Accordingly programmers must use the English based keywords irrespective of the natural languages in which the source codes are written. For a similar reason, the programmers must also use the character sets of the high level programming language.

Efficiency in developing program codes by non English speaking programmers is therefore hindered by the burden of having to use English based words which they are not familiar with. Many of these programmers also have to learn English so that they can understand the functions and purposes of the keywords.

The need to use the English based keywords also prevent automatic translation of source code from one natural language to another natural language as the keywords in English are necessary for the compiler to compile into machine code.

Compilers are difficult to write. It is therefore not practical to provide them for every natural language.

Computer operating systems such as Windows® are generally written in C or C++ programming language and they have hundreds of thousands and even millions of lines of source code written in English. Translation of the source code for the operating systems to present non-English interface is a very complex and difficult task. Accordingly, non-English operating systems are produced a long time after their corresponding English operating systems are marketed.

### OBJECT OF THE INVENTION

It is an object of the present invention to alleviate or to reduce to a certain level one or more of the prior art disadvantages.

### SUMMARY OF THE INVENTION

In one aspect therefor the present invention resides in a computer system for converting at least keywords in a program source code. The system/program comprises storage means adapted to store keywords of at least one programming language, the keywords being nominally used for programming source codes written in one natural language, and words in at least one other natural language corresponding to said keywords, and program code conversion means adapter to access said storage means for converting keywords or corresponding words in a program source code written in said one natural language or one of said at least one other language to corresponding words or keywords as stored in the storage means into a target code in another natural language.

In another aspect therefor the present invention resides in a computer program for converting at least keywords in a program source code. The software comprises storing means adapted to store in a storage means keywords of at least one programming language nominally used for programming source codes in one natural language and words in at least one other natural language corresponding to said keywords, and program code conversion means adapter to access said storage means for converting keywords or corresponding words in a program source code written in said one natural language or one of said at least one other natural language to corresponding) words or keywords as stored in the storage means into a target code in another natural language.

In a further aspect therefor the present invention resides in a computer operating system comprising interface language selection means adapted for selecting one from a plurality of natural languages for presenting system interface, storing means adapted to store keywords of the programming language used for programming the operating system source codes in one natural language and words in at least one other natural language corresponding to said keywords, and program code conversion means adapter to access said storage means for converting keywords or corresponding words in a program source code written in said one natural language or one of said at least one other natural language to corresponding words or keywords as stored in the storage means into a target code in another natural language selected for the interface.

In preference said storage means includes corresponding words in a plurality of other natural languages and the system further comprises a language selection means for selectively choosing the natural language of the target code. The language selection means may be arranged to automatically detect the natural language in which the source code is written, or provided with a source code language selection arrangement for choosing the natural language of the source code.

Advantageously the storage means includes a primary database containing the keywords and the corresponding words in said plurality of other natural languages, and a secondary database containing the keywords and the corresponding words in the chosen one said other natural languages. The code conversion means is adapted to access the secondary database for conversion of the keywords to corresponding words in the chosen natural language.

The storage means can also include a user defined database containing user provided words in one natural language and corresponding words in one or more other natural languages.

The program code conversion means may include a character replacement arrangement for replacing characters and/or signs in the target code which are unrecognisable by the programming language to ones which are recognised. Said unrecognisable characters and/or signs may accented letters and/or specific signs in a natural language. For example, in French the letters “ê”, “è” and “é” may be replaced by “e”.

Preferably the conversion means further includes a translator for translating words and/or signs other than the keywords and/or user defined words in the source code into one of said other natural languages. The invention can thus be used not only to convert the keywords but also to translate all other words and/or signs in a program code to another natural language.

The invention of the present invention allows program source codes including keywords of a programming language written in any natural language to be converted into a target code in another natural language in a manner that the target code a compilable by a compiler program into a machine code.

In a further aspect therefor the present invention resides in a compiler for program codes. The compiler comprises the system/software as hereinbefore described.

In a preferred form, the invention defines a set of interfaces for conversion and compilation of a program written in a programming language such as C++ or Windows® into various natural (spoken) languages. Hereafter, the suite of C++ language compilers that are defined by the invention, will be referred to as the language D. Additionally, D extends the Windows operating system into any of the target spoken languages.

The keywords of the C++ language are defined in English. The language D retains the English keywords when programming in English, but provides the keywords for expressing the same in any of a set of different spoken languages (see Appendix A). The D is executable and automatically converts the keywords of any given D program between spoken languages, and provides a facility for extending the conversion to cover any program variables within the source.

D may be used to define native compilers for languages other than English, using the source code of an existing English C++ compiler. Furthermore, D is symmetric in the sense that a native D Language compiler is capable of processing code from certain other language components (when only the keywords have been transformed). This can be done without actually translating the entire program.

Apart from altering the language keywords, the extension of C++ to D requires that the definition program identifiers be altered for each language component. In the case of some European languages, this modification includes accented characters from the standard ANSI code page (the same code page algorithm works for Spanish, Italian, French and German).

In C++, an identifier is an arbitrarily long sequence of letters, digits and the character ‘_’. The first character of an identifier must begin with a letter or ‘_’. In C++, a letter is defined to be an element of the set {a,b,c . . . , z,A,B,C, . . . ,Z}. Identifiers in the previously mentioned, European D language components include accented characters such as: à, é and [symbol] . The Vietnamese character set has a great variety of accents and requires a completely different algorithm for determining whether a character is an accented alphabetic character.

As well as the single byte D language components that have been already substantially developed, 3000 translations in Chinese (double byte) have been performed. The D language converter can also define the standard for programming C++ and Windows in Chinese. Accordingly, the invention can extend to native double-byte Chinese D compilers, and to native Arabic D compilers.

The programming interface for the Windows Operating Systems is in C and is referred to as Win32. The D converter provides transformations that define an operating system programming interface in languages other than English (for example, Spanish and Italian). By virtue of the fact that C is a subset of C++, any non-English D language component has an equivalent C subset embedded within.

This implies that the English Win32 interface maps to an equivalent C operating system interface in the target language component (for example, Spanish, in which case the transformed Win32 C interface is called Ven32). The same transformations that map the operating system interface also map application code written to that operating system standard. Additionally, the D converter may be applied to the source code of the operating system, itself to produce the source code of an equivalent operating system in a target language. When multiple operating systems result, the converter may later be modified so that it can be applied to executable code (rather than source code—although, that process is presently compiler dependent). This implies that D may be used to generate a suite of Windows Operating Systems that are convertible both at the source code level and at the executable level (.exe & .dll).

The invention is thus capable of defining and translating elements of the C++ language and of the Windows Operating Systems and programs in general.

The keywords of the C++ language (Appendix A1) have been extended to cover languages other than English. Appendix B1 lists the keywords of C++ defined for Spanish, French and Italian. As provided, keywords in these languages may include accented characters and identifiers expressed in these languages may also include any characters from the ANSI character set.

By performing permutations on programs containing these keywords (and character set compression for English), a program that is written in one natural language can be automatically, partially translated such that it may be compiled in a different language (only English C++ compilers are presently available). As shall be shown, French, Spanish and Italian programs may be coerced into a form suitable for compilation with an English compiler.

The invention is capable of performing translations to non-ANSI character sets. The system has already been fully mapped to Vietnamese and some translations for other non-ANSI languages have been performed.

Apart from providing translations for the C++ Language into various spoken languages, the system also provides translations that map the programming interface of the Windows Operating Systems into those languages. This involves:

rewriting the original programming interface to render it suitable for translation,

breaking the programming interface into thousands of individual parts,

providing translations for the operating system parts and

reassembling the translated parts to form a new interface (automatic).

By doing this, the invention defines a set of compatible operating system interfaces that forms the basis of a family of operating systems. An example of an operating system function being transformed is attached as Annex 1a. There are in excess of 1000 such functions in the Win32 interface. Like CreateWindowEx, each of the Win32 functions is automatically translated by the invention. Additionally, any code that has been written to conform to Microsoft's existing Win32 programming interface is automatically translatable into the target natural language/operating system. The mechanism provides an automatic way of mapping the enormous volume of existing code written to the Win32 interface to a chosen spoken language environment. This mapping capability extends to the source code of Windows.

In a preferred form, the invention defines a set of interfaces for conversion and compilation of a program written in the C/C++ language—for the Windows Operating Systems or otherwise. Hereafter, the suite of C++ language compilers that are defined by the invention, will be referred to as the Language D. Additionally, D extends the Windows operating system into any of the target spoken languages.

Using the source code of an existing English C++ compiler, D may be used to define native compilers for languages other than English. The keywords of the C++ language (Appendix A1) are presently defined only in English—for available English compilers. The language D retains the English keywords when programming in English, but provides keywords in supported spoken languages (Appendix B1). The D executable automatically converts the keywords of any D program between spoken languages, and provides a facility for extending the conversion to cover any program variables within the source.

Apart from altering the language keywords, the extension of C++ to D requires that the definition of program identifiers be altered for each language component. In the case of some European languages, this modification includes accented characters from the standard ANSI code page (the same code page works for Spanish, Italian, French and German). In C++, an identifier is an arbitrarily long sequence of letters, digits and the character ‘_’. The first character of an identifier must be a letter or ‘_’. Identifiers in the previously mentioned, European D components include accented characters such as: à, é and [symbol] . The Vietnamese character set has a great variety of accents and requires a completely different algorithm for determining whether a character is an accented alphabetic character.

In addition to the single byte D language components that have already been substantially developed, 3000 translations in Chinese (double byte) have been performed. The D language translator can also define the standard for programming C++ and Windows in Mandarin. Accordingly, the invention can extend to native double-byte Mandarin D compilers, and to native Arabic D compilers.

The programming interface for the Windows Operating Systems (Win 32) is in C. The D translator provides transformations that define an operating system programming interface in languages other than English (for example, French and Spanish). By virtue of the fact that C is a subset of C++, any non-English D language component has an equivalent C subset embedded within. Using that subset, the English Win32 interface maps to an equivalent C/C++ operating system interface in the target language component (for example, Spanish, in which case the transformed Win32 C interface is called Ven32). As previously mentioned, the same transformations that map the operating system also map application code written to that operating system standard; whereby, all Win32 applications are rendered translatable. The D translator may be applied to the source code of the operating system itself to produce the source code of an equivalent operating system in the target language. When multiple operating systems result, the translator may later be modified so that it can be applied to executable code (rather than source code). D may be used to generate a family of Windows Operating Systems that are convertible both at the source code level and at the executable level (.exe &. .dll).

### BRIEF DESCRIPTION OR THE DRAWINGS

In order that the present invention can be more readily understood and be put into practical effect reference will now be made to the accompanying drawings which illustrate embodiments of the present invention and wherein:—

FIG. 1 is a flow diagram showing certain elements in a C/C++ source code conversion system according to the present invention; and

FIG. 2 is a drawing showing a window interface on a computer system and the window is created according to a computer program the source code of which is attached as Annex 2.

FIG. 3 is a French version of the window interface shown in FIG. 2;

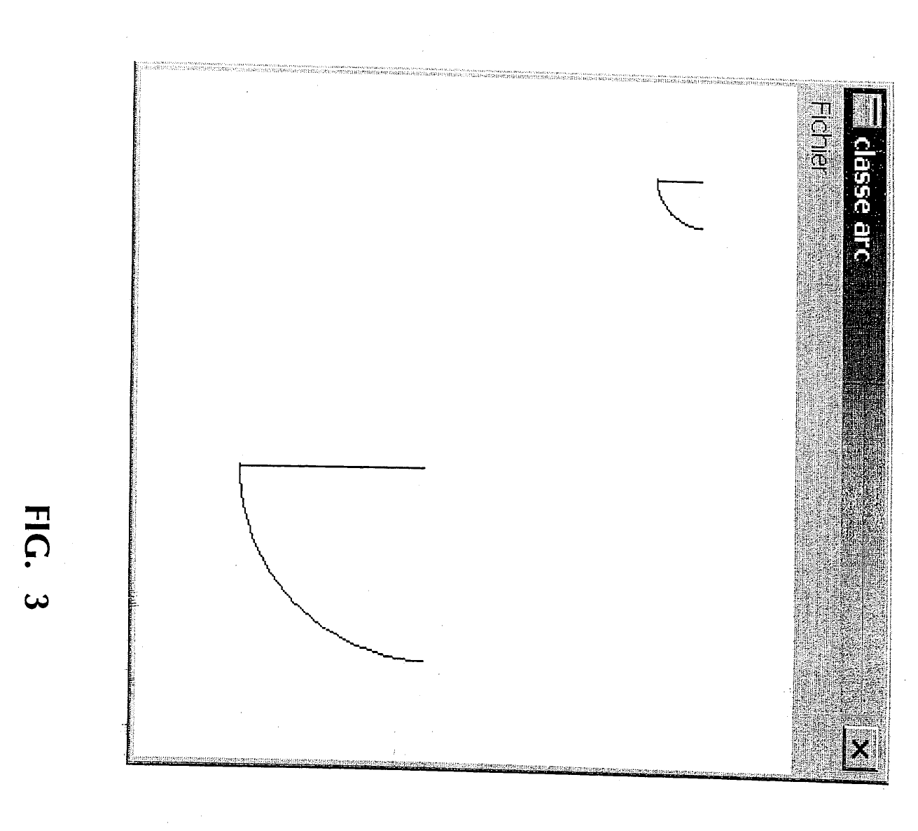

FIG. 4 is a Spanish version of the window interface shown in FIG. 2;

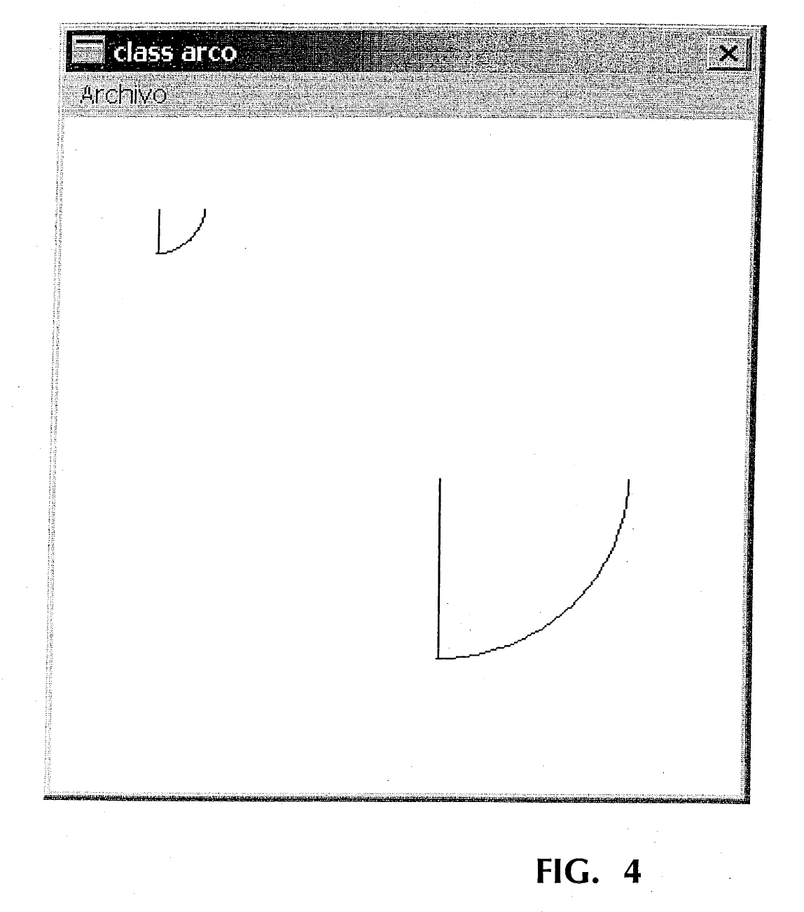

FIG. 5 is an Italian version of the window interface shown in FIG. 2 and generated by the program listed in Annex 4;

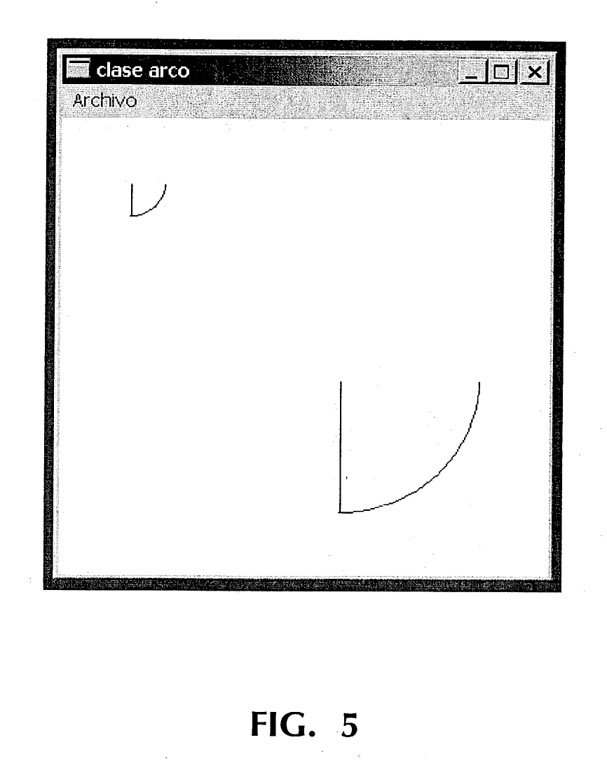

FIG. 6 is an example of an output in Spanish generated by the program of the present invention listed in Annex 5; and

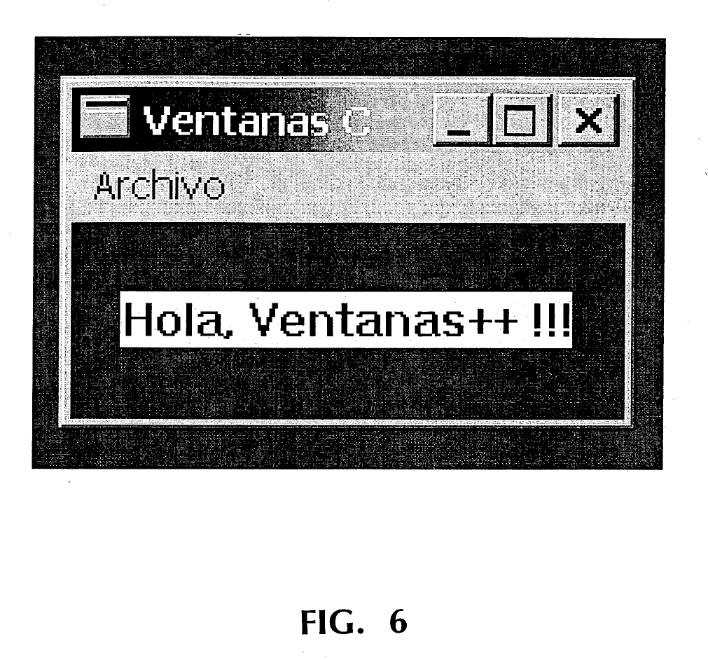

FIG. 7 is an example of an output in Italian generated by the program of the present invention listed in Annex 7.

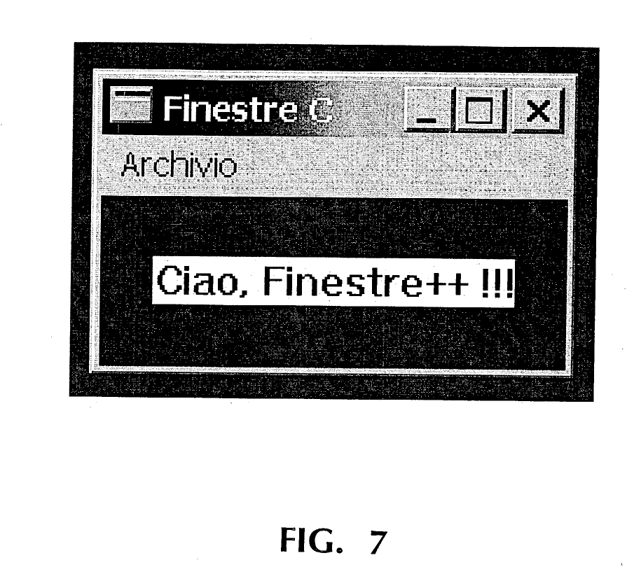

### DETAILED DESCRIPTION OF THE INVENTION

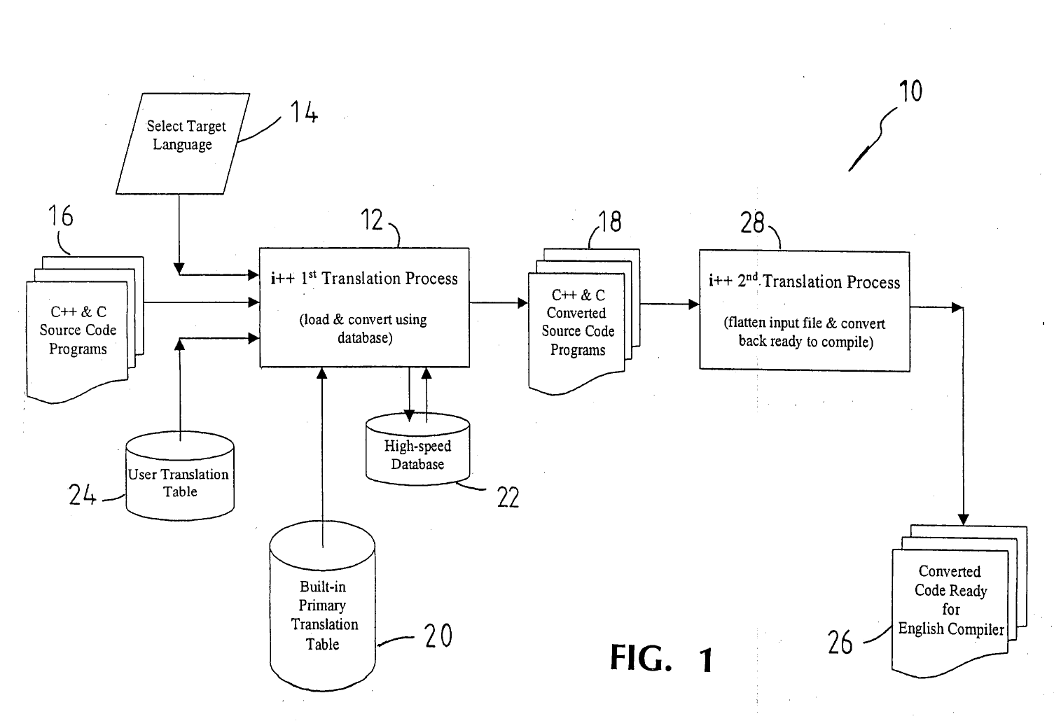

Referring to FIG. 1 there is shown a C/C++ program source code conversion system 10 (d.exe) according to the present invention. The system 10 has a program source code conversion means 12 which in this case, is adapted for converting C/C++ source code written including C/C++ keywords written in English, French, German, Italian, or Spanish into a form that can be compiled by a standard compiler for a computer system running under the Windows operating system.

The system 10 also has a target language selector 14 which is arranged to allow selection of converting a program source code 16 written in one of English, French, German, Italian and Spanish into another one of English, French and Spanish for a target source code 18.

The target language selector 14 therefore facilitates selection of the source and target language from among English, French, German, Italian and Spanish (or any other natural language). After selection of natural languages for source and target code, the system 10 interrogates a primary translation table 20 stored in memory—see Appendix C. The table 20 contains the lexicons for the languages English, French, German, Italian and Spanish (or any other natural language). The words in each lexicon include:

C/C++ keywords (including preprocessor keywords),

C/C++ application programming interfaces of the operating system (APIs) and

other interfaces of the operating system including manifest constants etc.

Once the natural language of the desired target code is selected the system 10 interrogates a primary conversion table 20 stored in a storage means (hard disk). The table 20 has corresponding keywords in English, French and Spanish. The keywords include interfaces of the operating system, C/C++ keywords (including preprocessor keywords), C/C++ application programming interfaces (C/C++APIs), Windows APIs, C/C++ constants, operating system constants, and the like.

The system 10 extracts the words for the source and target natural languages from the primary table 20 into a working database 22 for high speed access. The high-speed database is currently in the form of a balanced binary tree containing pairs of words in each entry (one word from the source language and another from the target language). The working database 10 ensures that the conversion process 12 is rapid.

The conversion means 12 also interrogates a user defined database 24 in which a user can set up specific corresponding words in different natural languages. The database 24 thus allow the user to have a high degree of flexibility in determining how non keywords are to be translated between different languages.

During the construction of the high-speed database, a user defined database 24 is incorporated. This table has two columns—the first column containing words from the source language and the second column containing the translations into the target language. The database 24 is useful for defining translations of individual elements within a specific application by determining how words not present in the primary database 20 are translated. The system 10 then creates the source code in the target language 18 that corresponds to the given input source code 16. Words present in the source code that appear in database 22 are converted to words in the selected target natural language. All other words in the source code are left unchanged when creating the target source code.

The system 10 then creates a target code for the source code, with all words and/or signs in the source code that appear in the database 22 and the database 24 converted to the corresponding words and/or signs in the target natural language. All other words in the source code can be left unchanged when creating the target code, or be automatically translated by a language translator.

The target code is compilable by a compiler unless it has accented letters.

Where the target code is in a language that has accented letters the system 10 has a further conversion process which flatten the target code by replacing the accented letters with corresponding letters in the standard ASCII character set.

For non English target codes the system 10 converts the keywords therein to English form so that the codes are compilable.

Accordingly, when the target language is other than English, the system has a further conversion process that:

1 removes accented ANSI characters, replacing them with the corresponding ASCII characters (for example: e and e are mapped to e) and

2 replaces the target natural language C++ keywords with the corresponding English C++ keywords.

This process renders the code compilable with an English compiler—despite being predominantly expressed in a non-English language. In future, when a French compiler becomes available, the invention will allow the compilation of non-French code (from the ANSI character set) using only the second of these steps to coerce it to a form suitable to the French compiler.

Pursuant to further elaborating the particulars of the invention, several key examples will now be presented. Two complete programs represented in three languages will be briefly discussed. One suite of programs demonstrates programming windows in C++, whilst the other suite gives a template for directly programming the operating systems in C. For both environments and all languages, the applications provide a template that is suitable for almost all windows applications in that language.

The C++ Suite of Applications

The fully defined (.cpt extension) main programs in may be found as follows.

| | | |
|---|---|---|
| French | Annex 3—The Main Program | arc.cpt |
| Italian | Annex 4—The Main Program | arco.cpt |
| Spanish | Annex 2—The Main Program | arco.cpt |

These C++ programs contain accents from the ANSI code page. To obtain the compilable version of these programs:

1. the accents are stripped and

2. the C++ keywords in the target language are replaced with their English equivalents.

This results in the English C++ compilable equivalents of the original full fledged C++/Windows Spanish, French and Italian applications:

| | | |
|---|---|---|
| French | Annex 3—The Preprocessed Main Program | arc.cpp |
| Italian | Annex 4—The Preprocessed Main Program | arco.cpp |
| Spanish | Annex 2—The Preprocessed Main Program | arco.cpp |

The compilable versions of the applications are then compiled and linked (with i++ DLLs and resources included) to form the application executable (.exe). Snapshots of the applications executing are provided in the associated annexes.

Only one of these applications requires manual construction; whereby, the remaining two applications may be machine generated via the D translator (which is exactly how they were obtained). Because of their advanced nature (in C++) these applications may appear less familiar than the C suite of applications to be discussed.

The C Suite of Applications

The C suite of applications use the “native” C interfaces defined for the language variants of the Windows operating systems under discussion. Because these interfaces are directly equivalent to existing Win32 code, their workings may be readily understood by present programmers. The three C applications are as shown in the table that follows.

Annexe 5 A sample Ven32 application (Spanish).

Annexe 6 A sample Fen32 application (French).

Annexe 7 A sample Fin32 application (Italian).

Operating System Interfaces

The presented Ven32, Fen32 and Fin32 applications are typical of standard Win32 English applications that are almost ubiquitous at present. To successfully compile these applications, the entire operating system must be defined in the given language. By virtue of the volume, neither the full C++ interface nor the C interface for the Windows operating system can be presented. However, pursuant to the demonstration of a portion thereof, the Spanish C interface for the Ventanas Subsystem has been presented in Annex 8. The Spanish C interface also contains a base operating system interface and a graphics subsystem interface.

The given file is somewhat equivalent to the Microsoft development file winuser.h. It differs in that:

1 the constants and data structures are defined elsewhere (within the C++ interface) and

2 a single function replaces two functions when UniCode is involved.

For this reason, the Ven32 file is very compact compared to its English counterpart Win32. Other Ven32 files exist that represent the Graphics Device Interface GDI (wingdi.h) and the Base Operating System (winnt.h and winbase.h), and like wapi.h they are compact.

Annex1 shows a listing of the core C++ keywords in the first column and the corresponding words in French, Spanish, and German in columns two, three and four respectively. C++ programmers can write program codes using corresponding keywords in French, Spanish or German as shown in the listing. For compiling the system 10 of the present invention is used to convert the corresponding keywords into English while keeping other words unchanged. Accordingly non English programmers need not have to learn English in order to code programs or use the unfamiliar English keywords in their program codes.

It should be noted the four natural languages shown are examples only. The system of the present invention can have considerably more languages including those that use double byte character sets in their writings. Chinese and Japanese are examples of the languages that use double byte character sets.

D defines a 2 dimensional matrix that encapsulates both the C++ language and Windows. The matrix at the heart of D is transformations for the definition of non-English Systems. Appendix B lists some examples of the transformations which illustrate certain transformations for the definition of the Spanish and Italian Systems (which in turn contain Ven32 and Fin32—the C Operating System Interface of D). The C++ and D keywords are embedded within the transformation definitions (see Appendix B for some examples) as well being separately listed in Appendix A. Thus, a column within the Matrix simultaneously defines the D language interface and the Operating System Interface.

When the substitutions within a column are assembled to form the Interface, the resultant operating system definition appears in the D Language. Appendix C contains a portion of Ven32 in Spanish. A sample D, C application in Spanish is shown in Appendix D. The code found in appendixD1 and appendixD2 was generated by the D translator from the code in appendixD3 (which conforms to the Win32 standard). The application code samples have a direct 1-1 correspondence. This is true for translated code that originally conformed to the Win32 interface.

For a particular target language, D presents a primary operating system interface (which is the non-English equivalent of C++), as well as a secondary C-equivalent interface (Appendix C). Appendix C contains only function declarations—not the data types. The operating system data types are defined predominantly in D. The header files defining these data types are presented in the Spanish language. Programs may be written to the C standard or to the newer standard that D contains.

As previously mentioned, the production of native D compilers is possible in languages other than English. Presently only English C++ compilers are available; however, the techniques of compilation of non-English code with an English C++ compiler apply symmetrically to other languages that share the ANSI character set (e.g. an Italian D compiler can be used to compile Spanish code, after keyword replacement has been performed).

The technique for compiling Spanish D code with an English C++ compiler is illustrated via a program that draws an arc in a window. The D source for the program is contained in the files arco.hpt and arco.cpt. These files are unable to be compiled with an English C++ compiler; although, they would be directly compilable using a native Spanish D compiler. To compile the application using English C++, the program must be modified in two ways:

1) keywords are replaced (see Appendix A) and

2) accents are removed.

The second of these operations is avoidable by incorporating accents into the English definition of C++. The resultant code is contained in the files arco.hpp and arco.cpp, and it is capable of being compiled with an English C++ compiler. The D code contained in arco.hpt and arco.cpt is transformable, whereas the modified code is not (transformations are defined with accents included). The corresponding, transformed, Italian D code has also been included, and like the Spanish, it may be processed for compilation with an English C++ compiler.

Sample—Italian

File arco.cpp

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

Although D automatically converts the language keywords and all identifiers for the operating system, identifiers specific to a program also require translation. D provides a mechanism for supplying additional translations when processing code so that the result is entirely in the target language.

D provides support to all natural languages including single byte languages such as English, Spanish, French, Italian, German and Vietnamese; and double byte languages such as Chinese and Japanese.

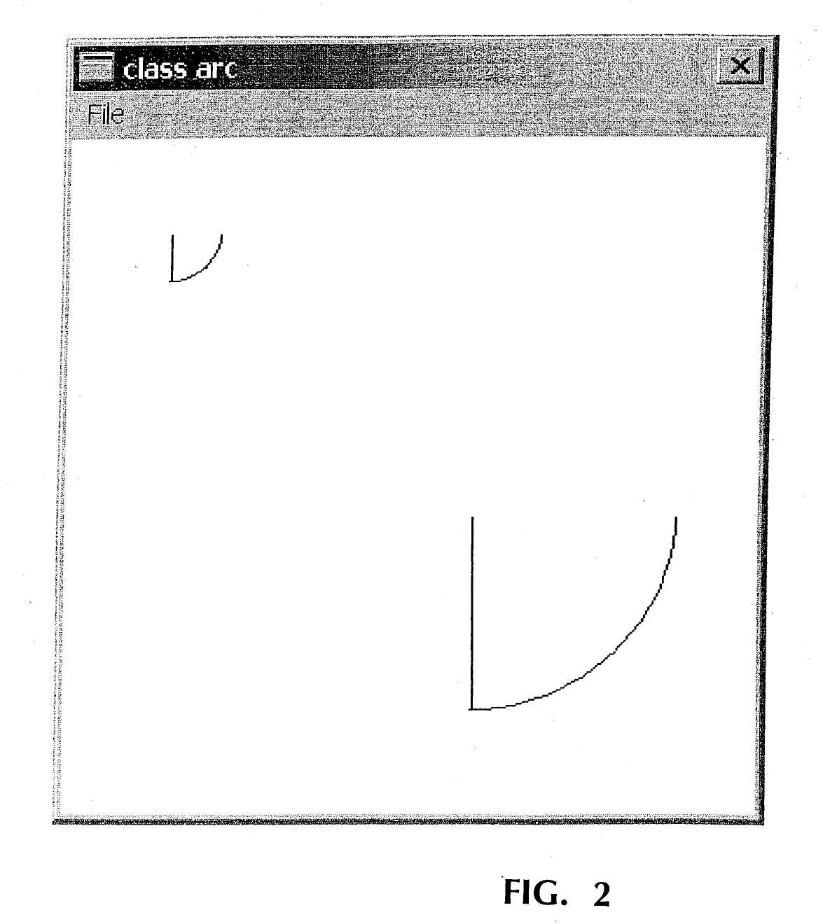

Annex 2 are a set of C++ program codes for an application to create the window shown in FIG. 2. These program codes are written in English and they include the following file components:

3. .cpp file containing the main source code for the application;

4. .hpp file containing the class definitions for the application;

5. .h file containing the constant definitions shared by the resource compiler (C/C++) and the application;

6. .rc file containing the menu definitions, string definitions; and

7. A module definition file determining the linking properties.

Annexes 3 and 4 are respective French and Spanish program codes of the Annex 1 application. As French and Spanish have accented characters in their writings and the accented characters must be replaced in order for the codes to be compilable by the C/C++ compiler. The source codes for theses languages are saved in files named with .cpt, .hpt, .ht and .rct extensions.

The system 10 of the present invention maps programs and resources from one accented form to another. The flattening conversion stage of the system 10 maps from the accented form to the non-accented form (i.e. .cpt to .cpp, .hpt to .hpp, ,ht to .h and .rct to .rc) and replaces the non-English C/C++ keywords with the corresponding English keywords. The converted files are compilable by the C/C++ compiler.

The flattening conversion stage can be performed automatically as the system 10 has been informed of the natural languages of the source and target codes.

The conversion and flattening stages of the present invention can be incorporated into any compiler program. This will allow compilers to be capable of compiling program codes including keywords written in any language.

Whilst the above has been given by way of illustrative example of the present invention many variations and modifications thereto will be apparent to those skilled in the art without departing from the broad ambit and scope of the invention as herein set forth.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

1. A computer system for converting at least keywords in program source code of a high level programming language having reserved keywords in a natural language, the computer system comprising storage means adapted to store the keywords of the programming language, the keywords being nominally used for programming the source code written in the natural language, and words in at least one other natural language corresponding to said keywords; and program code conversion means adapter to access said storage means for converting keywords or corresponding words in the program source code written in said natural language or one of said at least one other language, to corresponding words or keywords as stored in the storage means into a target source code in another natural language.

2. A computer program for converting at least keywords in program source code of a high level programming language having reserved keywords in a natural language, the computer program comprising storing means adapted to store in a storage means the keywords of the programming language nominally used for programming the source code in the natural language and words in at least one other natural language corresponding to said keywords, and program code conversion means adapter to access said storage means for converting keywords or corresponding words in a program source code written in said natural language or one of said at least one other natural language to corresponding words or keywords as stored in the storage means into a target source code in another natural language.

3. A computer operating system comprising interface language selection means adapted for selecting one from a plurality of natural languages for presenting system interface, storing means adapted to store in storage means keywords of the programming language used for programming the operating system source code in a natural language and words in at least one other natural language corresponding to said keywords, and program code conversion means adapter to access said storage means for converting keywords or corresponding words in a program source code written in said natural language or one of said at least one other natural language to corresponding words or keywords as stored in the storage means into a target code in another natural language selected for the interface.

4. The invention according to any one of claims 1 to 3 further comprising language selection means for selectively choosing the natural language for the target code, wherein said storage means includes corresponding words in a plurality of other natural languages and the language selection means being arranged to automatically detect the natural language in which the source code is written, or provided with a source code language selection arrangement for choosing the natural language of the source code.

5. The invention according to claim 4 wherein he storage means includes a primary database containing the keywords and the corresponding words in said plurality of other natural languages, and a secondary database containing the keywords and the corresponding words in the chosen one said other natural languages; the code conversion means being adapted to access the secondary database for converting the keywords to corresponding words in the chosen natural language.

6. The invention according to claim 5 wherein the storage means further including a user defined database containing user provided words in one natural language and corresponding words in one or more other natural languages.

7. The invention according to any one of claims 1 to 6 wherein the program code conversion means including a character replacement arrangement for replacing characters and/or signs in the target code which are unrecognisable by the programming language to ones which are recognised.

8. The invention according to claim 7 wherein said unrecognisable characters and/or signs including accented letters and/or specific signs in a natural language.

9. The invention according to any one of claims 1 to 8 wherein the conversion means further including a translator for translating words and/or signs other than the keywords and/or user defined words in the source code or interface into one of said other natural languages.

10. The invention according to any one of claims 1 to 9 wherein the invention being arranged so that a program source code including keywords of a programming language written in any natural language for conversion into a target code in another natural language, are converted in a manner that the target code a compilable by a compiler program into a machine code.

11. A compiler for compiling program source codes into executable computer instructions comprising the system according to claim 1 or the program according to claim 2.

12. The invention according to any one of claims 1 to 11 wherein the invention defines a set of interfaces for conversion and compilation of a program written in a programming language into various natural languages, said programming language including C++, Windows® and the like.

13. The invention according to any one of claims 1 to 12 wherein said programming language is C++, and said program conversion means being arranged to extend the C++ language to incorporate characters in character sets suitable for representing a natural language in said said at least one other natural language.

14. The invention according to claim 13 wherein said corresponding keywords including a set of keywords appropriate to the representation of the C++ language in any one the French, Italian and Spanish languages, being said at least one other natural language.

15. The invention according to claim 14 wherein said program code conversion means being arranged for cross-compilation of non-English program code by converting only C++ language keywords and making adjustments for accents of said at least one other natural language with accented words.

16. The invention according to-any one of claims 1 to 15 further including means for redefining programming interface of a computer Operating Systems so that the interface is divided into analytical parts for translation into said at least one other natural language.

17. The invention according to claim 16 wherein said interface redefining means having a table of interface parts of multiple operating system programming interfaces, each column in the said table represents the parts of an operating system programming interface in a particular natural language, and interface part translation means arranged to retrieve from the table program code of the interface parts into the code of the programming interface of said at least one other natural language.
